(19) United States
(12) Patent Application Publication
(10) Pub. No.: US 2020/0060233 A1
(43) Pub. Date: Feb. 27, 2020

(54) BEHAVIOR MODIFICATION SYSTEM AND METHOD OF USE

(71) Applicant: Michael D'Abruzzo, Garrison, NY (US)

(72) Inventor: Michael D'Abruzzo, Garrison, NY (US)

(21) Appl. No.: 16/109,881

(22) Filed: Aug. 23, 2018

(51) Int. Cl. A01K 15/02

(52) U.S. Cl. CPC A01K 15/02

(57) ABSTRACT

A behavior modification system enables the alteration of behavior in animals or people through the application of a series of stages. Each stage builds upon the preceding stage and is able to be adjusted as the student progresses through the stages. The process begins by understanding the root of the behaviors to be changed and continues to advanced stages where the desired behaviors are able to be fined tuned.

### BACKGROUND

### 1. Field of the Invention

The present invention relates generally to educational systems, and more specifically, to systems for altering the behavior of a subject or pupil.

### 2. Description of Related Art

Educational systems are well known in the art and are effective means to communicate knowledge from one person to another. Educational systems have been applied to behavioral education and particularly to animal training. In conventional animal training systems and methods, reinforcement and punishment are given to the subject. For example, when a dog is tasked to sit, and does, it is presented with a treat, if not, it is punished with physical force. Through repeated attempts of this command and consequence sequence the dog learns to obey commands, perform tasks, acquires traits or the like.

One of the problems commonly associated with animal training systems is its limited use. For example, the method of providing rewards to an animal does not work or function on all animals or even all dogs. Those animals with whom the system does not work are deemed untrainable.

Additionally, it should be appreciated that it becomes cumbersome and time consuming for animal trainers and handlers to troubleshoot with every animal subject, wherein each subject may respond better to one type of training as opposed to another. It can be a particularly daunting task for the trainer to be faced with the seemingly endless variations in the environment, subject, training plan and even the trainer's attitude when implementing one or more training plans. The present invention provides a means to more efficiently troubleshoot the animal subject, wherein the present invention provides for an improved means to find what is going wrong, and proceeding with learning and implementing information and skills in a certain order for better success from the start of training.

Accordingly, although great strides have been made in the area of animal training systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a pyramid diagram of a behavior modification system in accordance with a preferred embodiment of the present application;

FIG. 2 a diagram of one embodiment of the system of FIG. 1;

FIG. 3 is a flow chart of the ethology stage of FIG. 1; and

FIG. 4 is a diagram of the diagnosis stage of FIG. 1;

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional animal training systems. Specifically, the invention of the present application teaches the means where by animals or other pupils can be trained to alter their behavior. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

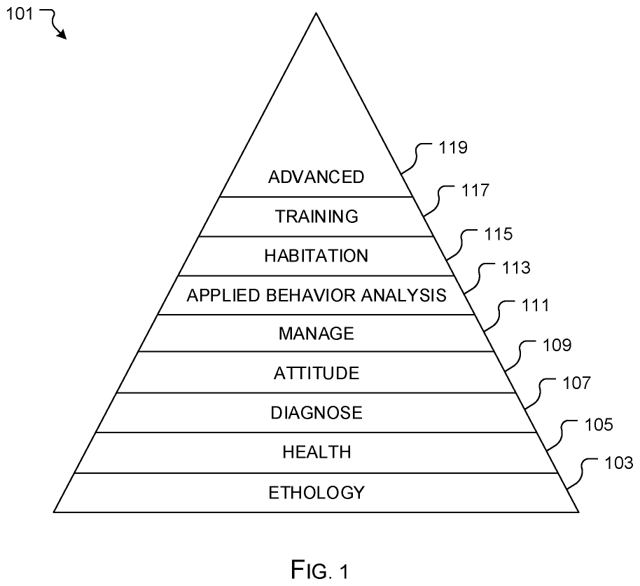

Referring now to the drawings wherein like reference characters identify corresponding or similar elements throughout the several views, FIG. 1 depicts a pyramid diagram of a behavior modification system in accordance with a preferred embodiment of the present application. It will be appreciated that system 101 overcomes one or more of the above-listed problems commonly associated with conventional animal training systems.

While animals, particularly dogs have been discussed it is contemplated that the system 101 could be used on any animal, person or the like that exhibits a behavior. It will be further understood that system 101 enables the evaluation and altering of behaviors wherever they are found.

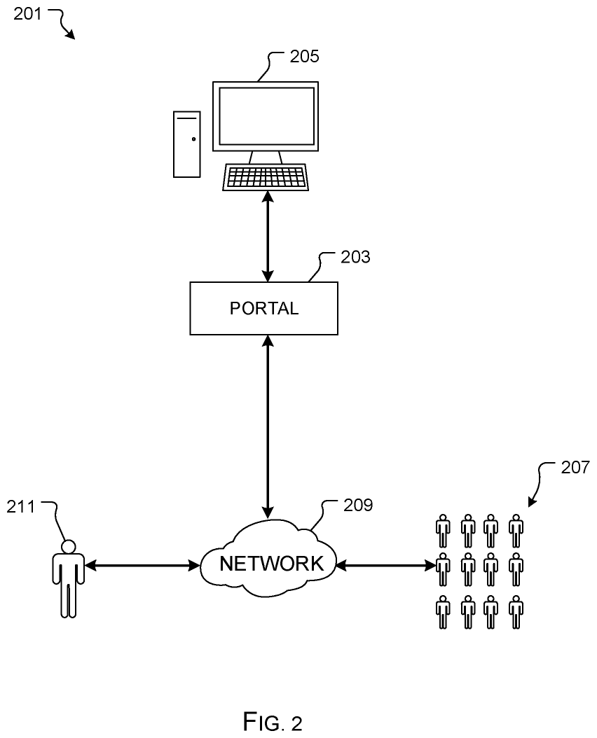

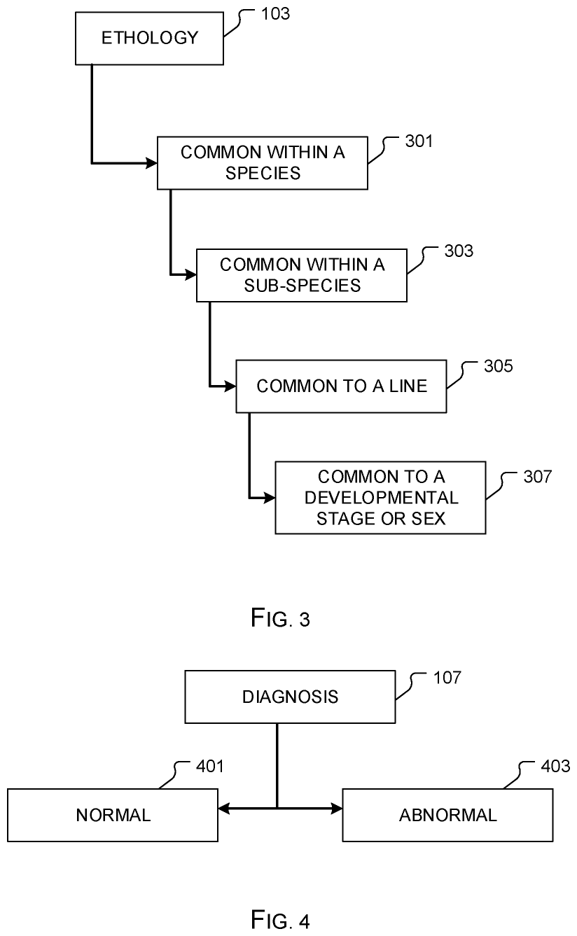

In the contemplated embodiment, system 101 includes successive stages where the preceding stages affect the subsequent stages. The stages of the present embodiment include ethology 103, health 105, diagnose 107, attitude 109, manage 111, applied behavior analysis 113, habitation 115, training 117 and advanced 119. It is further contemplated and is depicted by FIG. 2 that system 101 could operate via a portal 203 that is activated by a computing device 205. It is contemplated that users 207 access the system 101 on portal 203 via a network 209 and that contributors 211 also access the system 101 on the portal 203 via a network 209 to provide information with respect to the stages thereof.

It is contemplated that each stage includes information, processes, activities or other content that enable the system 101 to progress to the next stage. For example stage ethology 103 includes evaluating a pupil or student for traits or common to the species 301, those common to the sub-species 303, those common to a line 305 and those common to the developmental stage or sex 307 thereof. It will be understood and appreciated that this stage 103 evaluates the pupil to prepare a foundation upon which behavior can further analyzed and altered.

It should be appreciated that one of the unique features believed characteristic of the present application is that stages: ethology 103, health 105, diagnose 107, attitude 109, manage 111, applied behavior analysis 113, habitation 115, training 117 and advanced 119 capture and plan for the altering behaviors in any student or pupil.

As a further example the diagnosis 107 stage includes the classification of behaviors as normal 401 or abnormal 403. It will be understood and appreciated that portal 203 and computing device 205 enable the collection of data relative to the behavior of students or pupils and that his data facilitates the classification of the behaviors as normal 401 or abnormal 203.

While these stages, ethology 103, health 105, diagnose 107, attitude 109, manage 111, applied behavior analysis 113, habitation 115, training 117 and advanced 119 have been disclosed it will be understood that these stages could be altered, divided, added or otherwise modified to facilitate the altering of behaviors.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spiritthereof.

What is claimed;:

1. A behavior modification system comprising:
a plurality of stages sequenced to create conditions for the success of the subsequent stages of altering behavior;
wherein the stages include ethology; health; diagnose; attitude; manage; applied behavior analysis; habitation; training; and advanced.

1. The system of claim 1 wherein the behaviors or exhibited or instilled in an animal.

2. The system of claim 1 wherein the behaviors or exhibited or instilled in a person.
